(19) United States
(12) Patent Application Publication
(10) Pub. No.: US 2014/0193698 A1
(43) Pub. Date: Jul. 10, 2014

(54) ELECTROCHEMICAL CELL, CELL CASE AND METHOD FOR MAKING SAME

(71) Applicant: GENERAL ELECTRIC COMPANY, Schenectady, NY (US)

(72) Inventors: Jinghua Liu, I, Shanghai (CN); Huiqing Wu, Shanghai (CN); Michael Alan Vallance, Loudonville, NY (US); David Charles Bogdan, JR., Scotia, NY (US)

(73) Assignee: General Electric Company, Schenectady, NY (US)

(21) Appl. No.: 13/735,309

(22) Filed: Jan. 7, 2013

(51) Int. Cl. H01M 2/02; H01M 10/04

(52) U.S. Cl. CPC H01M 2/024; H01M 10/04
USPC 429/164; 429/163; 429/176; 429/185; 29/623.1; 29/623.2

(57) ABSTRACT

An electrochemical cell comprises a negative electrode, an positive electrode, a cell case, and a solid electrolyte. The cell case comprises an outer case and an inner case. The solid electrolyte defines a first chamber to receive the negative electrode and is disposed within the inner case to define a second chamber. The second chamber is separated from and is in ionic communication with the first chamber to receive the positive electrode. The electrochemical cell further comprises a first current collector extending into the first chamber. Wherein an open upper end of the inner case extends beyond an open upper end of the outer case. A cell case and a method for making an electrochemical cell are also presented.

### BACKGROUND OF THE DISCLOSURE

The invention relates generally to electrochemical cells, cell cases and methods for making the cell cases of the electrochemical cells. More particularly, this invention relates to rechargeable or secondary cells, cell cases having corrosion resistance, and methods from making the cell cases of the rechargeable or secondary cells.

Rechargeable cells, also referred to as secondary cells, have been widely used in energy storage applications. Typically, due to high energy storage capability, high power density and long cyclic life, the rechargeable cells, such as sodium metal halide cells or sodium sulfur cells are used in relatively larger-scale energy storage applications, for example, in electric vehicles.

In some designs of such rechargeable cells, solid electrolyte tubes are designed to accommodate sodium, and such configurations are referred to as central sodium configurations so as to improve the performance of the rechargeable cells. However, in such central sodium configurations, positive electrodes, such as sulfur or nickel halide of the rechargeable cells are thus disposed outside of the solid electrolyte tubes to directly contact cell cases. This may result in corrosion of the cell cases by cell reactants during operation of the rechargeable cells.

There have been attempts to increase the corrosion resistance of the cell cases, for example, noble metal, such as nickel is used to make the cell cases. However, this results in increasing of the cost of the cell cases and the cost of such rechargeable cells is increased accordingly, which is not cost-effective for applications of such rechargeable cells.

Therefore, there is a need for new and improved rechargeable cells, cell cases, and methods for making the cell cases of the rechargeable cells.

### BRIEF DESCRIPTION OF THE DISCLOSURE

An electrochemical cell is provided in accordance with one embodiment of the invention. The electrochemical cell comprises a negative electrode, a positive electrode, a cell case, and a solid electrolyte. The cell case comprises an inner case and an outer case receiving the inner case. The solid electrolyte defines a first chamber to receive the negative electrode and is disposed within the inner case of the cell case to define a second chamber therebetween. The second chamber is separated from and is in ionic communication with the first chamber to receive the positive electrode. The electrochemical cell further comprises a first current collector extending into the first chamber. Wherein an open upper end of the inner case extends beyond an open upper end of the outer case.

A cell case of an electrochemical cell is provided in accordance with another embodiment of the invention. The cell case comprises an outer case having an open upper end and an inner case disposed within the outer case. The inner case has an open upper end extending beyond the open upper end of the outer case.

Embodiment of the invention further provides a method for making an electrochemical cell. The method comprises introducing a negative electrode into a first chamber defined by a solid electrolyte of an electrochemical cell, introducing a positive electrode into a second chamber defined between the solid electrolyte and an inner case of a cell case of the electrochemical cell, and separated from and in ionic communication with the first chamber; extending a first current collector into the first chamber. Wherein the cell case further comprises an outer case receiving the inner case, and wherein an open upper end of the inner case extends beyond an open upper end of the outer case.

These and other advantages and features will be better understood from the following detailed description of embodiments of the invention that is provided in connection with the accompanying drawings.

### BRIEF DESCRIPTION OF THE DRAWINGS

FIG. 1 is a schematic diagram of an electrochemical cell in accordance with one embodiment of the invention;

FIG. 2 is a schematic diagram of a cell case of the electrochemical cell;

FIGS. 3-4 are exemplary perspective diagrams of an inner case and an outer case of the cell case shown in FIG. 2 in accordance with one embodiment of the invention; and

FIGS. 5-7 are schematic diagrams showing a method for making the inner case of the cell case in accordance with one embodiment of the invention.

### DETAILED DESCRIPTION OF THE INVENTION

The embodiments of the present disclosure will be described hereinbelow with reference to the accompanying drawings. In the following description, well-known functions or constructions are not described in detail to avoid obscuring the disclosure in unnecessary detail.

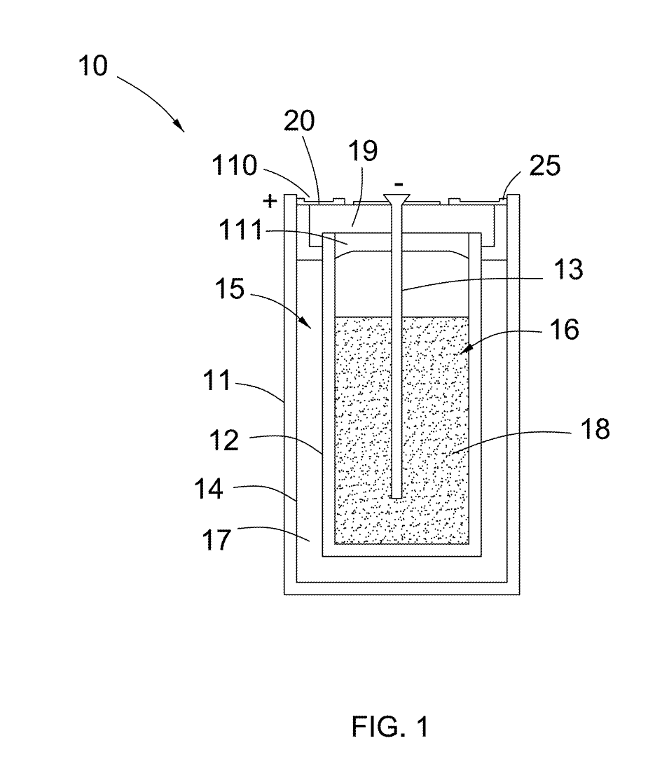

FIG. 1 illustrates a schematic diagram of an electrochemical cell 10 in accordance with one embodiment of the invention. In embodiments of the invention, the electrochemical cell 10 comprises a rechargeable cell used in energy storage applications. Although a single electrochemical cell 10 is illustrated, a plurality of the electrochemical cells 10 may be connected in parallel and/or in series to provide suitable voltages and battery capacities for relatively large-scale energy storage.

As illustrated in FIG. 1, the electrochemical cell 10 comprises a cell case 11, a solid separator 12, and a current collector 13. The cell case 11 is configured to receive or accommodate the solid separator 12. The solid separator 12 defines a first chamber 16 and is spaced away from an inner surface 14 of the cell case 11 for accommodation into the cell case 11 so that a second chamber 15 is defined therebetween.

In the illustrated example, the first chamber 16 is separated from and in ionic communication with the second chamber 15 through the solid separator 12. As used herein, the term “ionic communication” refers to traversal of ions between the first chamber 16 and the second chamber 15 through the solid separator 12.

The first chamber 16 is configured to receive anodic materials acting as a negative electrode 18 and the second chamber 15 is configured to receive cathodic materials acting as a positive electrode 17. As used herein, the cathodic materials are materials that supply electrons during a discharging process of the electrochemical cell 10, and are present as part of a redox reaction. The anodic materials are configured to accept electrons during the discharging process of the electrochemical cell 10, and are also present as part of the redox reaction.

In non-limiting examples, the anodic materials may include alkaline metal, such as sodium, lithium and potassium, and may be in a molten state during use. Suitable materials of the cathodic materials may include a transition metal selected from the group consisting of titanium, vanadium, niobium, molybdenum, nickel, cobalt, manganese, iron and silver. In certain applications, the transition metal may be employed in the form of a salt, such as nitrates, sulfides, chlorides or halides thereof. In one non-limiting example, the cathodic materials include chloride salts of the transition metals, such as nickel chloride. In other examples, the cathodic materials may include any other suitable materials, such as sulphur.

Based on employment of different anodic and cathodic materials, different electrochemical cells may be formed. It should be noted that the electrochemical cell 10 is not limited to any specific electrochemical cells. In some examples, the electrochemical cell 10 may comprise a metal-sulphur cell, such as a sodium sulphur cell or a metal-metal halide cell, such as a sodium metal halide cell including a sodium-nickel halide cell.

In the illustrated example, the cell case 11 has a cylindrical cross section and defines an open upper end 110 so that the solid separator 12 is disposed within the cell case 11 through the open upper end thereof. Alternatively, the cell case 11 may have any other suitable cross sections, such as a rectangular cross section or a polygonal cross section. Similarly, the solid separator 12 also defines an open upper end (not labeled) and may also have any suitable cross sections, such as a cylindrical cross section, a rectangular cross section or a polygonal cross section to provide a maximal surface area, for example, for alkali metal ion transportation during operation. In addition, the cell case 11 and/or the solid separator 12 also have suitable width-to-length ratios, respectively. In one non-limiting example, the cell case 11 and/or the solid separator 12 have a tube-like shape, respectively.

In embodiments of the invention, the solid separator 12 acts as a solid electrolyte to transport the ions, such as alkali metal ions between the first chamber (a anode chamber) 16 and the second chamber (a cathode chamber) 15. Suitable materials for the solid electrolyte 12 may include an alkali-metal-beta′-alumina or alkali-metal-beta″-alumina. In certain applications, an upper portion of the solid electrolyte 12 may include alpha alumina and a lower portion of the solid electrolyte 12 may include beta alumina since the alpha alumina may be an ionic insulator.

In certain applications, in order to facilitate ion transportation within the cathodic materials, such as sulphur during operation, the electrochemical cell 10 may comprise an electrolyte (not shown) disposed within the second chamber 15 in a liquid state to mix with the cathodic materials therein. Based on employment of different cathodic materials, non-limiting examples of the electrolyte in the liquid state may include sodium chloroaluminate (NaAlCl₄), lithium chloroaluminate (LiAlCl₄), or potassium chloroaluminate (KAlCl₄).

The current collector 13 comprises electrically conductive materials, such as metals or alloys. In one example, the current collector 13 comprises metals including, but not limited to copper. For the illustrated arrangement, the current collector 13 extends into the first chamber 16 for electrical current collection and reduction of internal electric resistance of the electrochemical cell 10 during operation. In some examples, the current collector 13 may comprise a cylindrical rod. Alternatively, the current collector 13 may have any other suitable shapes, such as an irregular shape or a rectangular shape.

In some embodiments, the cell case 11 may also comprise electrically conductive materials so as to act as another current collector for electrical current collection and reduction of the internal electric resistance of the electrochemical cell 10 during operation. In the illustrated example, since the first and second chambers 16, 15 are configured to receive the respective anodic and cathodic materials, the cell case 11 and the current collector 13 act as an cathodic (second) current collector and a anodic (first) current collector respectively during operation for electrical connection with a positive terminal and a negative terminal of an external circuit (not shown).

In certain applications, due to high operating temperature, the use of moisture-sensitive reactants or the use of corrosive liquids, as depicted in FIG. 1, the electrochemical cell 10 further comprises a sealing element 19 disposed on the upper ends (not labeled) of the cell case 11 and the solid electrolyte 12 to seal and separate the electrochemical cell 10 from the exterior thereof so as to prevent exposure of cell reactants to the external atmosphere.

Additionally, a cover 20 of the electrochemical cell 10 is provided to be disposed on the upper end of the cell case 11 to provide suitable mechanical integrity to assemble and seal the elements, such as the solid electrolyte 12 and the sealing element 19 into the cell case 11. A holder 111 is disposed on an upper end of the solid electrolyte 12. In some examples, the cover 20 may have a suitable shape, such as a circular shape or a rectangular shape, and may be assembled onto the inner surface of the cell case 11. Different techniques, such as welding or brazing may be used to assemble the cover 20 onto the cell case 11.

Suitable materials for the sealing element 19 may include glassy materials, a cermet or a combination thereof. Non-limiting examples of the glassy materials may include phosphates, silicates and borates. Non-limiting examples of the cermet may include alumina and a refractory metal. The refractory metals may include molybdenum, rhenium, tantalum, tungsten or other suitable metals. The cover 20 may comprise metals or alloys. In one example, the cover 20 comprises nickel.

It should be noted that the arrangement in FIG. 1 is merely illustrative. For easy illustration, some elements of the electrochemical cell 10 are not illustrated, such as the liquid electrolyte and an insulator for electric insulation of the cell case 11 and the solid separator 12. Although the cell case 11 acts as the cathodic current collector to electrically connect with the positive terminal of an external circuit, an additional electrically conductive element (not shown) may be disposed between and electrically connect the cell case 11 and an external circuit.

Thus, during operation, taking the sodium sulphur cell as an example, in a discharging state, the sodium in the first chamber 16 turns into sodium ions releasing electrons to an external circuit, and the sodium ions pass through a wall of the solid separator 12 reaching the cathode (positive electrode section) 17 in the second chamber 15 to react with electrons from the sulphur and the external circuit to produce sodium polysulfides and generate a suitable voltage.

In charging state, a voltage from an external circuit is applied on the electrochemical cell 10, the sodium polysulfides release electrons to the external circuit to produce sulfur and sodium ions, and the sodium ions pass through the wall of the solid separator 12 reaching the anode (negative electrode section) 18 in the first chamber 16 and react with electrons supplied by the external circuit to be electrically neutralized, thereby the electrical energy being converted into chemical energy for next discharging. Other electrochemical cells, such as sodium nickel halide cells also have similar operation processes as the sodium sulphur cells.

Generally, a cell case of an electrochemical cell is designed to have suitable mechanical integrity and corrosion resistance to the cell reactants, such as the sodium polysulfides so as to ensure stable and safe operation. Further, since the cost of the corrosion resistant cell case is usually a larger portion of the total material cost of the electrochemical cell, the cell case may also be designed with a relatively lower cost.

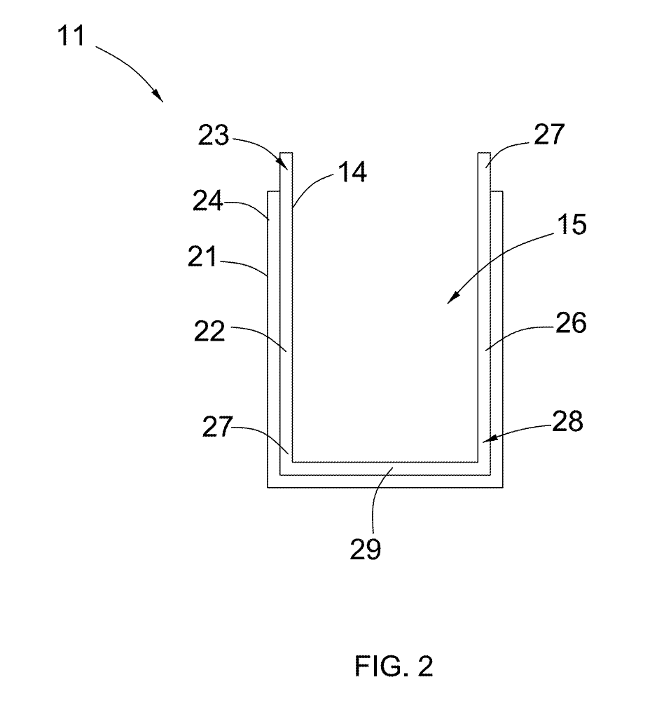

FIG. 2 illustrates a schematic diagram of the cell case 11 of the electrochemical cell 10 shown in FIG. 1. As illustrated in FIG. 2, the cell case 11 comprises an outer case 21 and an inner case 22 detachably disposed on and mating with an inner surface of the outer case 21 so as to ensure electrical connection therebetween for electric current collection during operation. In non-limiting examples, a roll welding technique may be used to assemble the inner case 22 onto the outer case 21. In one example, one or more welding lines (not shown) are formed to assemble the inner case 22 onto the inner surface of the outer case 21.

The inner case 22 defines the second chamber 15 to accommodate the cathodic materials so that the inner case 22 comprises corrosion resistant materials to prevent corrosion of the cell case 11 by the cell reactants, such as the sodium polysulfides. Non-limiting examples of the corrosion resistant materials of the inner case 22 may include noble metals or other suitable materials. The noble metals may include, but not limited to nickel, molybdenum, and combinations thereof. The other inner materials may include carbon and graphite. In one example, the inner case 22 comprises nickel.

In some examples, a thickness of the cell case 11 is in a range of from about 0.4 mm to about 1 mm. A thickness of the inner case 22 may be in a range of from about 0.05 mm to about 0.65 mm. Accordingly, compared to convention cell cases, the reduction of the thickness of the corrosion-resistant inner case 22 results in reduced cost.

The outer case 21 is disposed outside the inner case 22 to electrically connect an external circuit and has suitable mechanical integrity to reinforce and ensure the inner case 22 not to bulge and burst under operating conditions of high pressure and high temperature so as to ensure stable and safe operation of electrochemical cell 10. The thickness of the outer case 21 may be greater than the thickness of the inner case 22 and may conduct current with low electrical resistance. In some embodiments, the outer case 21 includes different materials from the materials of the inner case 22. Suitable materials for the outer case 21 may include mild steel or any other suitable materials, such as stainless steel, galvanized steel, non-ferrous alloys, or ceramic to further reduce the cost of the cell case 11.

For the illustrated example, in order to prevent the cell reactants from corroding the outer case 21 of the cell case, an open upper end 23 of the inner case 22 extends beyond an open upper end 24 of the outer case 21. A flange 25 (shown in FIG. 1) of the cover 20 contacts with the inner surface 14 of the open upper end 23 of the inner case 22 so as to assemble the cover 20 onto the cell case 11.

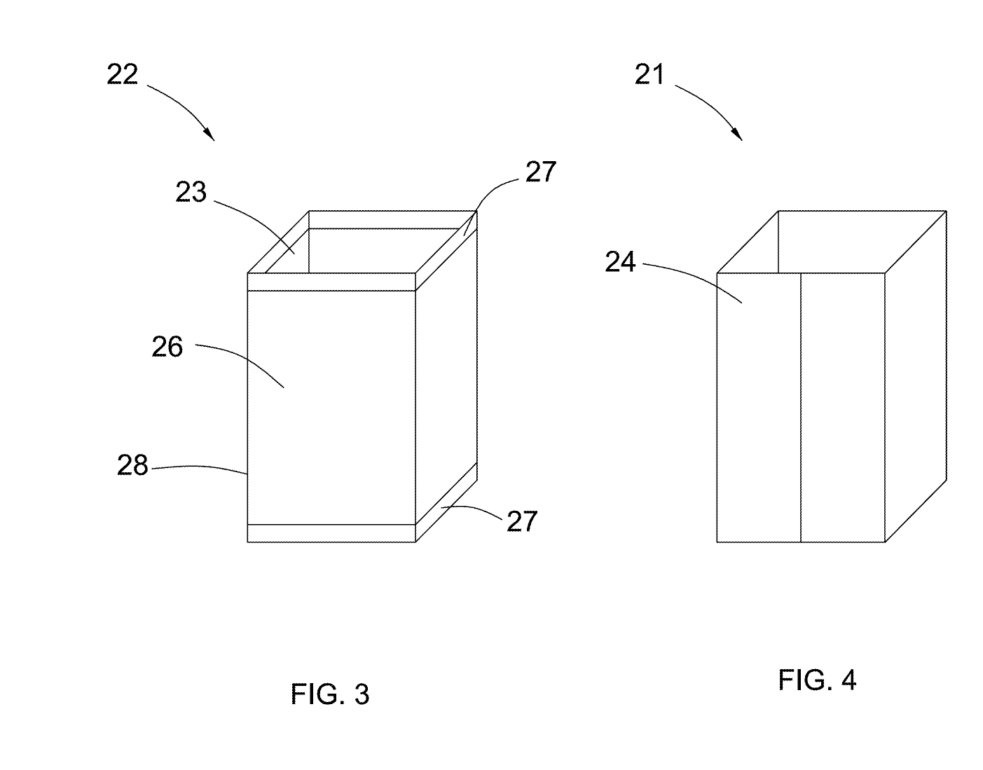

In non-limiting examples, the thickness of the inner case 22 is relatively smaller, and thus it may be not suitable to directly mate the cover 20 with the inner case 22. Accordingly, as depicted in FIGS. 2-3, the inner case 22 comprises a body section 26 and a collar section 27 disposed around and extending beyond an open upper end 23 of the body section 26. The thickness of the collar section 27 is greater than the thickness of the body section 26 to facilitate mating with the flange 25 of the cover 20.

In one non-limiting example, the laser welding is employed to weld the flange 25 of the cover 20 onto the collar section 27 of the inner case 22. Since the inner case 22 is welded with the cover 20, the outer case 21 is not in contact with the cover 20, and thus is isolated from the welding process and protected during making the cell 10. In certain applications, the collar section 27 may not be employed.

In some embodiments, the outer case 21 may include materials having a relatively lower cost, and may be manufactured to have various shapes by conventional techniques, such as drawing or laser welding techniques resulting in a relatively lower cost. Similarly, the inner case 22 may also be manufactured by techniques resulting in a relatively lower cost. For example, during making a nickel inner case 22 having a rectangular cross section, the drawing technique is employed to draw a nickel tube with two open ends and a plurality of selected dies (not shown) are employed to fabricate the body section 26.

In certain applications, the drawing technique may also be employed to fabricate two collar sections 27 with rectangular cross sections. Subsequently, the roll welding technique is employed to weld the two collar sections 27 onto two open ends 23, 28 of the body section 26 so that the two collar sections 27 are disposed around and extend beyond the respective open ends 23, 28 of the body section 26.

Finally, a bottom element 29 is assembled, for example, is welded onto the lower collar section 27, as illustrated in FIG. 3, to fabricate the inner case 22 with the upper open end 23 and the lower open end 28 sealed hermetically to accommodate the cathodic materials. In certain applications, the materials of the bottom element 29 may include nickel or any other suitable materials. The methods for making and assembling the collar sections on the body section may not be employed.

Accordingly, the inner case 22 is fabricated cost-effectively. The drawing technique and the roll welding technique have high efficiency for mass production of the inner case 22. Thus, the cost for manufacturing the inner case 22 is reduced. Although the sections of the inner case 22 are illustrated to be fabricated separately, in certain applications, the different sections of the inner case 22 may be fabricated integratively.

FIG. 4 illustrates a schematic perspective diagram of the outer case 21 mating with the inner case 22. During assembly, the roll welding technique may also be employed to make the inner case 22 in intimate contact with an inner surface (not labeled) of the outer case 21 to ensure electrical conduction therebetween. After fabrication, the cell case 11 is used for fabrication of the electrochemical cell 10.

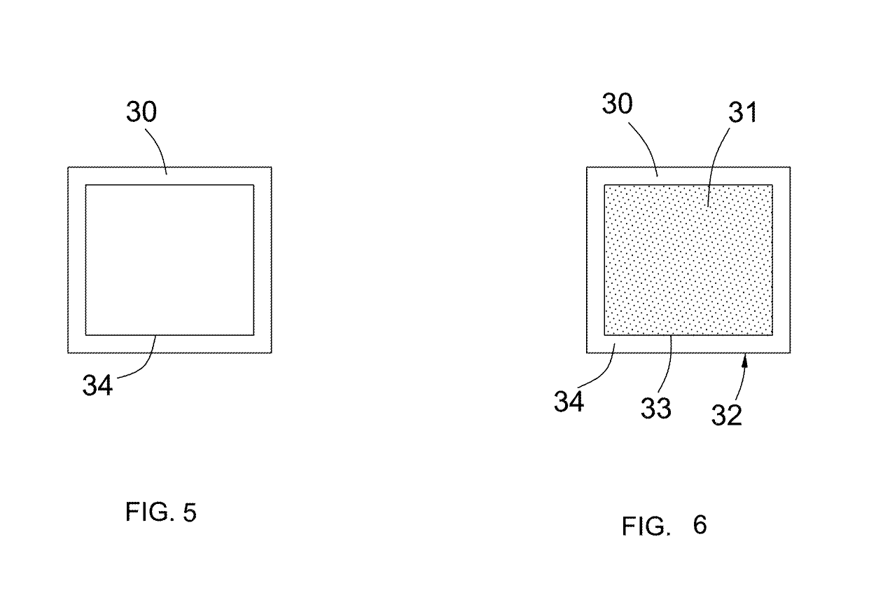

FIGS. 5-7 illustrate a method for fabrication of the inner case 22 in accordance with another embodiment of the invention. As illustrated in FIG. 5, a planar sheet of an annular collar section 30 is provided with a rectangular cross section. Then, as illustrated in FIG. 6, a planar sheet of a rectangular body section 31 is disposed onto the annular collar section 30 to form an intermediate element 32 in a configuration that four sides 33 of the body section 31 contact with respective four sides 34 of the annular collar section 30. Each side 34 of the collar section 30 extends beyond the respective side 33 of the body section 31.

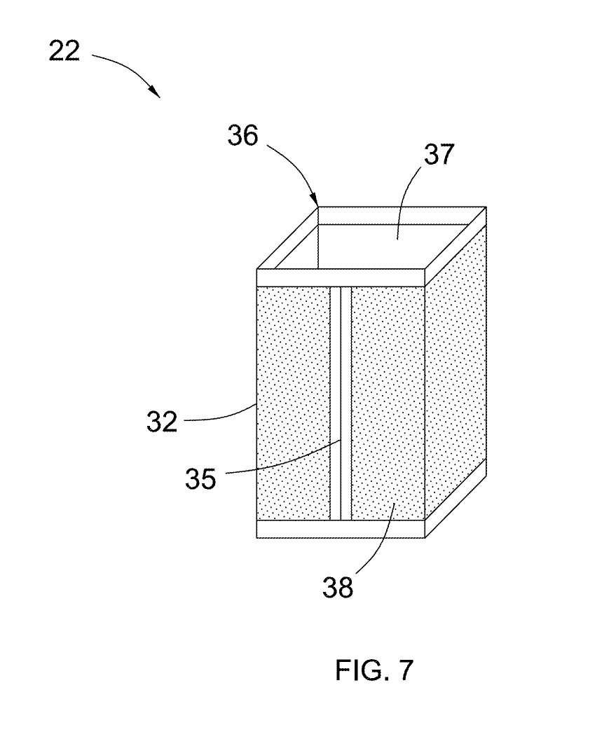

Subsequently, as illustrated in FIG. 7, the intermediate element 32 is bent and connection portions 35 of the bent element (not labeled) are mated together to form a body 36 of the inner case 22. Finally, a bottom element 29 (shown in FIG. 2) is assembled onto a lower open end of the body 36 to fabricate the inner case 22 with an open upper end 37 and a lower portion 38 sealed hermetically.

After being fabricated, the inner case 22 is assembled onto the outer case 21, for example, by the roll welding technique for accommodating the cathodic materials. The cover 20 is mated with the inner case 22 for making the cell 10. Thus, the outer case 21 is distal from the cover 20 and is thus shielded from the welding process due to mating of the cover 20 and the inner case 22. It should be noted that the arrangements in FIGS. 6-7 are merely illustrative. In some examples, any other suitable techniques may be employed for fabrication and assembly of the inner case 22 and the outer case 21.

In non-limiting examples, after fabrication of the intermediate element 32, the intermediate element 32 is assembled onto the outer case 21 having a planar shape (not shown) via the roll welding or spot welding. Then, the combination of the planar of the intermediate element 32 and the outer case 21 are bent for fabrication of the cell case 11.

In embodiments of the invention, the cell case 11 of the electrochemical cell 10 comprises the outer case 21 and the inner case 22 detachably and in contact with the outer case. Different techniques may be employed to fabricate and assemble the outer case 21 and the inner case 22 together. In one example, one or more welding lines are formed to assemble the outer case 21 and inner case 22 together. This results in that the cell case 11 is fabricated efficiently and at reduced cost, relative to fabrication with a monolithic case body.

The inner case 22 is fabricated to be hermetically sealed, for example using the drawing technique, and thus the leakage issue may be eliminated. In some applications, the inner case 22 may be formed with the collar section to mate with the cover 20 of the electrochemical cell 10, for example using the roll welding technique, which is advantageous for mating the cover 20 with the inner case 22 because the body section of the inner case 22 has a smaller thickness. In addition, due the mating of the cover 20 and the inner case 22, the outer case 21 is shielded from the welding process and protected. Further, due to contact between the outer case 21 and the inner case 22, the cell case 11 has lower electrical resistance.

The thickness of the corrosion-resistant inner case 22 is relatively smaller and the outer case 21 includes suitable materials having lower cost, which reduces the cost of the cell case and the cost of the electrochemical cell 10 accordingly, relative to a monolithic, corrosion-resistant cell case, for example. In addition, the open end of the inner case 22 extends beyond the open end of the outer case 21 so as to protect the outer case from corrosion of the cell reactants during operation of the electrochemical cell 10. Compared to cell cases of conventional electrochemical cells, due to low cost, high fabrication efficiency, and high corrosion resistance of the cell case 11, the electrochemical cell 10 is not only cost-effective but also has stable and safe operating capability.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

What is claimed is:

1. An electrochemical cell, comprising:
a negative electrode;
a positive electrode;
a cell case comprising an inner case and an outer case receiving the inner case;
a solid electrolyte defining a first chamber to receive the negative electrode and disposed within the inner case of the cell case to define a second chamber therebetween, and wherein the second chamber is separated from and in ionic communication with the first chamber to receive the positive electrode;
a first current collector extending into the first chamber; and
wherein an open upper end of the inner case extends beyond an open upper end of the outer case.

2. The electrochemical cell of claim 1, wherein the inner case is detachably disposed on the outer case.

3. The electrochemical cell of claim 1, wherein the inner case comprises a body section and a collar section disposed around and extending beyond an open upper end of the body section.

4. The electrochemical cell of claim 3, further comprising a cover mating with the collar section of the inner case to seal the cell case, and wherein the outer case is distal from the cover.

5. The electrochemical cell of claim 3, wherein a thickness of the collar section is greater than a thickness of the body section, and wherein the thickness of the body section is in a range of from about 0.05 mm to about 0.65 mm.

6. The electrochemical cell of claim 1, wherein a thickness of the outer case is greater than a thickness of the inner case.

7. The electrochemical cell of claim 1, wherein the cell case acts as a second current collector, wherein the inner case comprises one of nickel, molybdenum, and combinations thereof.

8. The electrochemical cell of claim 7, wherein the outer case comprises different materials from the materials of the inner case, and wherein the outer case comprises one of mild steel, stainless steel, galvanized steel, non-ferrous alloys.

9. The electrochemical cell of claim 1, wherein each of the outer case, inner case and the solid electrolyte has a tube-like shape.

10. The electrochemical cell of claim 1, wherein the negative electrode comprises alkaline metal and the positive electrode comprises one of sulphur and transition metal chloride.

11. A cell case of an electrochemical cell, comprising:
an outer case having an open upper end; and
an inner case disposed within the outer case, and the inner case having an open upper end extending beyond the open upper end of the outer case.

12. The cell case of claim 11, wherein the inner case is detachably disposed on the outer case.

13. The cell case of claim 11, wherein the inner case comprises a body section and a collar section disposed around and extending beyond an open upper end of the body section.

14. The cell case of claim 13, wherein a thickness of the collar section is greater than a thickness of the body section, and wherein the thickness of the body section is in a range of from about 0.05 mm to about 0.65 mm.

15. The cell case of claim 11, wherein the cell case comprises electrically conductive materials, wherein the inner case comprises one of nickel, molybdenum, and combinations thereof, and wherein the outer case comprises different materials from the inner case.

16. A method for making an electrochemical cell, comprising:
introducing a negative electrode into a first chamber defined by a solid electrolyte of an electrochemical cell;
introducing a positive electrode into a second chamber defined between the solid electrolyte and an inner case of a cell case of the electrochemical cell, and separated from and in ionic communication with the first chamber;
extending a first current collector into the first chamber; and
wherein the cell case further comprises an outer case receiving the inner case, and wherein an open upper end of the inner case extends beyond an open upper end of the outer case.

17. The method of claim 16, wherein the inner case is detachably disposed on the outer case.

18. The method of claim 16, wherein the inner case comprises a body section and a collar section disposed around and extending beyond an open upper end of the body section, and wherein the body section is fabricated using a drawing technique.

19. The method of claim 18, further comprising assembling a cover onto the collar section of the inner case to seal the cell case, wherein a thickness of the collar section is greater than a thickness of the body section, and wherein the outer case is distal from the cover.

20. The method of claim 16, wherein the inner case comprises a body section and a collar section, and wherein the method further comprises providing a planar sheet of the body section and an annular collar section disposed around and extending beyond sides of the body section to fabricate the inner case having a tube-like shape.
